(19) United States
(12) Patent Application Publication
(10) Pub. No.: US 2011/0141598 A1
(43) Pub. Date: Jun. 16, 2011

(54) DISK SURFACE DEFECT INSPECTION METHOD AND APPARATUS

(75) Inventor: Hideki MOCHIZUKI, Kamisato (JP)

(73) Assignee: Hitachi High-Technologies Corporation

(21) Appl. No.: 12/967,095

(22) Filed: Dec. 14, 2010

(30) Foreign Application Priority Data
Dec. 14, 2009 (JP) 2009-282530

(51) Int. Cl. G11B 5/02

(52) U.S. Cl. 360/25; G9B/5.026

(57) ABSTRACT

There is provided a detect inspection method and apparatus capable of performing a quick process of determining whether defects on a disk form an annular scratch defect or an island defect, by detecting an annular scratch defect in sum track areas with a deviation exceeding the standard deviation of an amount of defects detected in radius, in the histogram data containing the number of defects in radius, or by detecting an island defect in sum angle areas with a deviation exceeding the standard deviation of an amount of defects detected in angle, in the histogram data containing the number of defects in angle. Thus, the defect detection process can be performed step by step, by separating the annular scratch defect or the island defect from the other detects. As a result, a process load on the data processor can be reduced even if the number of detected defects increases.

### FIELD OF THE INVENTION

The present invention relates to a disk surface defect inspection method and apparatus. More particularly, the present invention relates to a disk surface defect inspection method and apparatus for detecting surface defects on a magnetic disk, or on a glass substrate of the magnetic disk, by a quick process for determining whether the detected defects form an annular scratch defect, an island defect, or other defects, and for classifying the defect shape.

### BACKGROUND OF THE INVENTION

There have been used optical measurement techniques to detect surface defects on a disk such as a magnetic disk or a semiconductor substrate. For example, JP-A No. 89336/1987 discloses a technique for inspecting foreign matters or pattern defects by irradiating a laser beam on a semiconductor substrate. If a foreign matter is present on the semiconductor substrate, the scattered light from the foreign matter is detected and compared to the last detection result of the semiconductor substrate of the same type. This is publicly known to those skilled in the art.

Further, U.S. Pat. No. 5,471,298 discloses a measurement technique for measuring the size of particles (or crystal defects) of an inspection sample, by irradiating a laser beam on the inspection sample, receiving the scattered light from the particles (or the crystal defects) of the inspection sample, and converting the received light into an image.

Furthermore, as described in JP-A No. 66263/2001, there is known a disk surface defect inspection apparatus that can detect defects by irradiating a laser beam on an inspection area of a disk, and receiving the scattered light from the inspection area. Further, a dedicated light receiving element is provided for annular scratch defect detection. Thus, the apparatus selectively detects an annular scratch defect and determines the continuity of the defect in the annular scratch defect detection.

Still further, JP-A No. 66263/2001 discloses a disk surface defect inspection method or apparatus using a process program to recognize each defect shape by determining the continuity of defects in both radial and circumferential directions. Then, the detected defects are grouped into a single defect to determine and classify the defect shape.

In the defect inspection of a recording medium used in computer systems, such as a magnetic disk or a glass substrate of the magnetic disk, there is an increase in the detection sensitivity due to the recent development of the high density recording media. The increase in the detection sensitivity increases the number of detected defects while reducing the size of the defects. This leads to a problem that the process load on a data processor used for grouping defects increases, requiring a lot of time for the inspection.

There is also a problem with the detected defects having a very small size. In this case, the data processing using the light receiving element specific to the annular scratch defect as described in Patent Document 3, even adds an extra process. This leads to an increase in the process load by the additional process.

### SUMMARY OF THE INVENTION

The present invention addresses the problems of the prior art, and aims to provide a disk surface defect inspection method and apparatus capable of detecting surface defects on a magnetic disk by a quick process for determining whether the defects form a circumferential scratch, namely, an annular scratch defect, or an island defect.

The present invention also aims to provide a disk surface defect inspection method and apparatus capable of detecting surface defects on a magnetic disk, by a quick process for determining whether the defects form an annular scratch defect, an island defect, or other defects, and for classifying a defect shape.

In other words, the disk surface defect inspection method and apparatus according to the present invention includes: a defect data acquisition step for inspecting an entire surface of a disk to detect defects, and acquiring data of the detected defects together with position coordinates on the disk; a radial histogram generation step for dividing the entire surface of the disk into a large number of areas at a predetermined width in a radial direction of the disk, to set a large number of sum tracks to calculate the total number of the defects, and generating histogram data containing the number of defects in each of the large number of sum tracks in radius, with the number of defects in each sum track as a frequency; or an angular histogram generation step for dividing the entire surface of the disk into a large number of angles at a predetermined equal angle in a circumferential direction of the disk, to set a large number of sum angle areas to calculate the total number of the defects, and generating histogram data containing the number of defects in each of the large number of sum angle areas in angle, with the number of defects in each sum angle area as a frequency; a step for calculating the standard deviation of the histogram data containing the number of defects detected in the sum tracks in radius, and calculating the standard deviation of the histogram data containing the number of defects detected in the sum angle area in angle; and a defect inspection step for detecting an annular scratch defect in the histogram data containing the number of defects in radius, with respect to each sum track with a deviation higher than the standard deviation of the particular histogram data, or for detecting'an island defect in the histogram data containing the number of defects in angle, with respect to each sum angle area with a deviation higher than the standard deviation of the particular histogram data.

According to the present invention, it is possible to detect an annular scratch defect in sum tracks with a deviation exceeding the standard deviation of an amount of defects detected (the number of defects detected) in radius, in the histogram data containing the number of defects in radius (hereinafter referred to as the radial histogram). It is also possible to detect an island defect in sum angle areas with a deviation exceeding the standard deviation of an amount of defects detected in angle, in the histogram data containing the number of defects in angle (hereinafter referred to as the angular histogram). In this way, the defect detection process can be performed step by step, by separating the annular scratch defect or the island defect from the other defects. As a result, a process load on the data processor can be reduced even if the number of detected defects increases.

In this case, the annular scratch defect is determined based on the standard deviation of the radial histogram. This is because the annular scratch defect is on a circumference in a certain radius range. In other words, when an annular scratch defect is present in a certain radius range, the number of defects detected in the sum track area of the particular radius range is significantly larger than the standard deviation of the radial histogram. Also the island defect is determined based on the standard deviation of the angular histogram. This is because an island defect is included in a certain sum angle area of the disk that is divided into equal angles in the circumferential direction. In other words, when an island defect is present in a certain sum angle area, the number of defects detected in the particular sum angle area is significantly larger than the standard deviation of the angular histogram.

As described above, the annular scratch defect determination and the island defect determination can be classified according to the standard deviations of the radial and angular histograms. Thus, it is possible to determine each determination target and perform the defect determination. In addition, the amount of process data of the determination target can be reduced in each determination of the shape of the defects forming annular scratch defect or island defect. Thus, the process load on the data processor for defect detection is reduced. After such a step-by-step process, the process proceeds to the next step of detecting the shape and the like of the remaining defects other than the annular scratch defect and the island defect. For this reason, the amount of data to be processed in the detection process is further reduced.

As a result, the present invention allows for a quick process in the disk surface defect inspection method and apparatus, to determine whether the defects are an annular scratch defect, an island defect, or other defects, or to classify the defect shapes.

It is to be noted that when the target disk is discrete track media (DTM), the number of defects is large, so that the advantage of the quick process of the defect inspection is particularly significant.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram of an example of a surface defect inspection apparatus to which the present invention is applied;

FIG. 2 is a schematic view of a defect plot in which defects are plotted on a disk to show the classification of the defects into an annular scratch defect and an island defect;

FIG. 3A is a view of a histogram of the defects detected in radius;

FIG. 3B is a view of a histogram of the defects detected in angle;

FIG. 4 is a flow chart illustrating a step-by-step process for performing the annular scratch defect determination and the island defect determination, to determine the defect shape according to the standard deviations;

FIG. 5A is a flow chart illustrating a simple process of detecting an annular scratch defect; and

FIG. 5B is a flow chart illustrating a simple process of detecting an island defect.

### DESCRIPTION OF THE PREFERRED EMBODIMENT

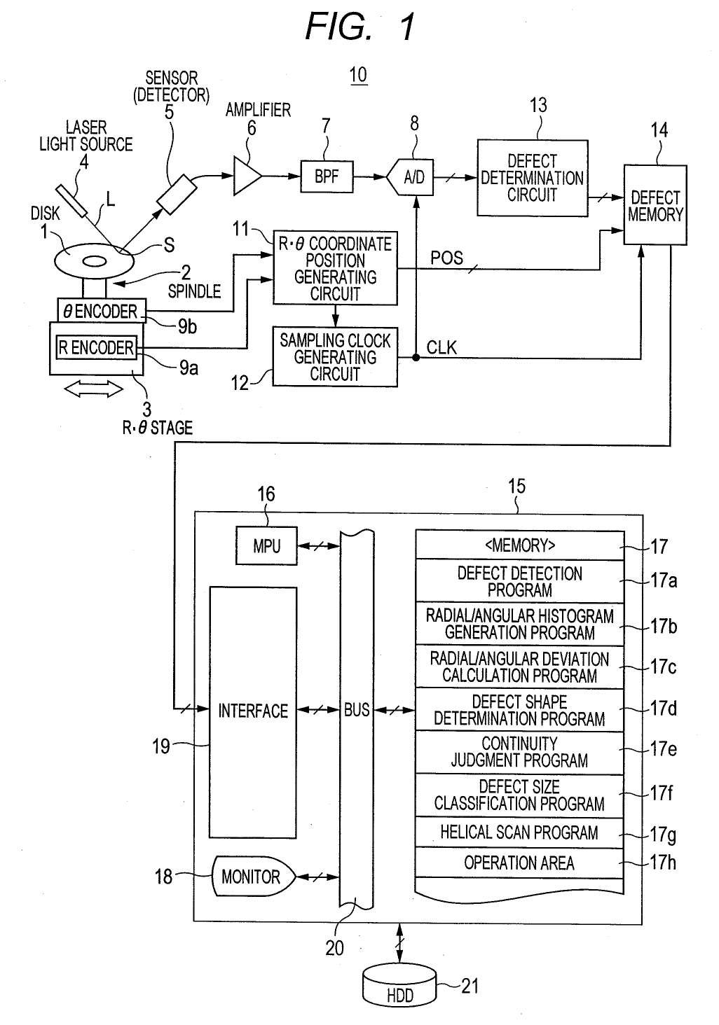

In FIG. 1, reference numeral 10 denotes a surface defect inspection apparatus of a magnetic disk. Reference numeral 1 denotes a magnetic disk (hereinafter referred to as a disk) to be inspected. The disk 1 is detachably inserted into a spindle 2 mounted on an R·θ stage 3.

The R·θ stage 3 includes an R encoder 9a for generating a distance pulse corresponding to the distance of the spindle 2 in the disk radial direction (R direction). The spindle 2 includes a θ encoder 9b for generating an angle pulse corresponding to a rotation angle θ of the disk 1.

Reference numeral 4 denotes a laser light source. A laser beam L from the laser light source 4 is irradiated onto and reflected from an inspection area S of the disk 1. The reflected light is input to a sensor (detector) 5 including a light receiving element, or photodiode, such as APD or CCD.

The light reception signal generated in the sensor 5 is amplified by an amplifier 6, and added to an A/D conversion circuit (A/D) 8 through a band-pass filter (BPF) 7. In the A/D 8, the level (voltage) of the light reception signal is converted to a digital value. Then, the digitally converted light reception signal (hereinafter the light reception signal) is compared to a predetermined threshold (threshold level) in a defect determination circuit 13, to determine whether the value of the light reception signal exceeds a predetermined threshold.

When the value of the light reception signal exceeds the threshold, it is determined to be a defect. In this case, the defect determination circuit 13 outputs a bit pulse, or a defect bit, to a defect memory 14 as a defect detection signal. For example, defect bit 1 shows presence of a defect while defect bit 0 shows absence of a defect.

The A/D 8 and the defect memory 14 are supplied with a clock CLK from a sampling clock generating circuit 12, respectively. In response to the clock CLK, the level of the light reception signal is converted to a digital value by the A/D 8. Also, in response to the clock CLK, the determination data result (defect bit) of the light reception signal is stored in the defect memory 14, together with the position data POS (the data of the coordinate position of the defect on the disk).

In other words, when the defect bit is “1”, which shows the presence of a defect, the position data POS of the coordinates of the defect at this time is written to the defect memory 14 according to the defect bit. In this way, the position data POS is sequentially stored in a predetermined area of the defect memory 14.

In this case, only the position data POS may be stored in the defect memory 14. It is also possible that the light reception level of the light reception signal at the defect position is stored, together with the defect bit in addition to the position data POS. In FIG. 1, the light reception level of the light reception signal at the defect position is obtained from the defect determination circuit 13.

The position data POS, which is input to the defect memory 14, is the data of the coordinates corresponding to the current scan position of the laser beam L. The position data POS is input to the defect memory 14 from the R·θ coordinate position generating circuit 11, in the form of the coordinates (the position of the defect detected) on the disk in two dimensions R, θ of the inspection area S of the disk 1 to which the laser beam L is irradiated.

The R·θ coordinate position generating circuit 11 receives an angle pulse indicating the rotation amount in the θ direction, from the θ encoder 9b. The R·θ coordinate position generating circuit 11 also receives a distance pulse indicating the distance in the R direction, from the R encoder 9a. Then, the R·θ coordinate position generating circuit 11 generates the coordinates (R, θ) as data.

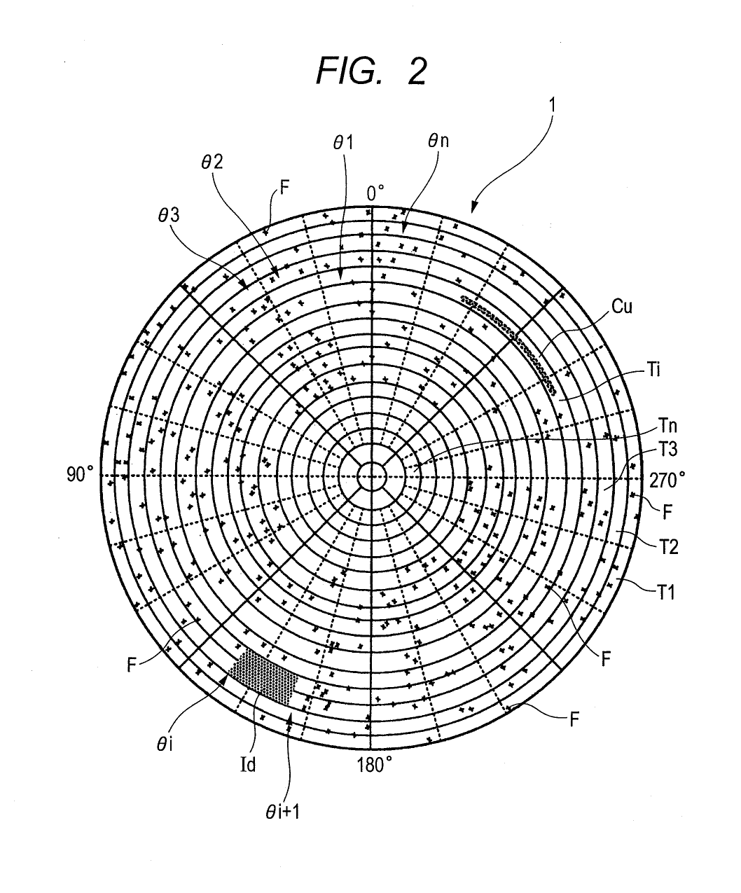

FIG. 2 is a schematic view of a defect plot in which defects are plotted on a disk to show the classification of the defects into an annular scratch defect and an island defect. However, actually the number of divided tracks in the radial direction and the number of divided angles in the circumferential direction are much larger than those shown in FIG. 2, which will be described below. FIG. 2 is a schematic view illustrating the annular scratch defect and the island defect, with a reduced number of divisions in both radial and circumferential directions to enlarge each divided area.

Reference symbol Cu denotes an annular scratch defect, reference symbol Id denotes an island defect, and reference symbol F denotes other defects.

As shown in FIG. 2, the entire surface of the disk 1 is divided into a large number of areas at a predetermined width in the radial direction of the disk 1. In this way, a large number of tracks (hereinafter sum tracks) Tl to Tn are set on the disk 1 to calculate the total number of defects in the individual sum tracks. Further, the entire surface of the disk 1 is divided into a large number of angles at a predetermined equal angle in the circumferential direction of the disk 1. In this way, a large number of angle areas (hereinafter sum angle areas) θl to θm are set on the disk 1 to calculate the total number of defects in the individual sum angle areas.

In the sum tracks Tl to Tn and the sum angle areas θl to θm, it is assumed that the annular scratch defect Cu is present on the sum track Ti, and that the island defect Id is present in the sum angle areas θi and θi+1.

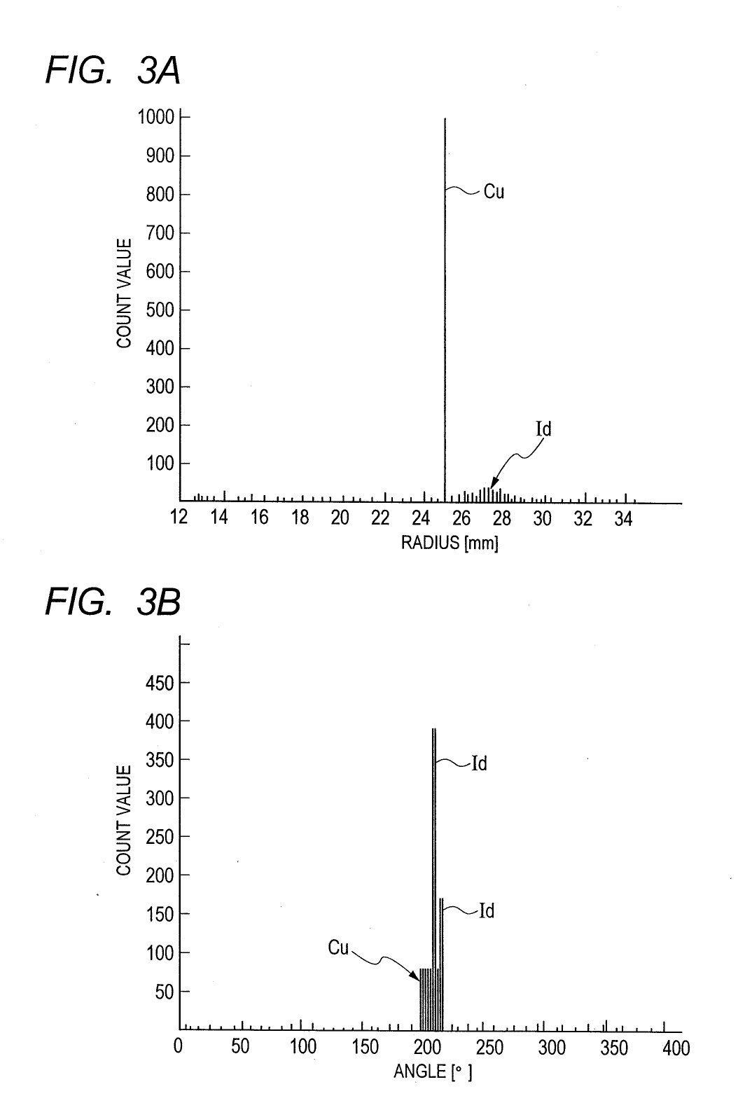

FIG. 3A shows an example of the radial histogram. The radial histogram is the data obtained by detecting defects in each of the sum tracks Tl to Tn in FIG. 2, counting the number of defects detected in each sum track, and calculating the total number of the detected defects. In the radial histogram, the vertical axis represents the sum values as the frequencies, and the horizontal axis represents the radial values.

FIG. 3B shows an example of the angular histogram. The angular histogram is the data obtained by detecting defects in each of the sum angle areas θl to θm in FIG. 2, counting the number of defects detected in each sum angle area, and calculating the total number of the detected defects. In the angular histogram, the vertical axis represents the sum values as the frequencies, and the horizontal axis represents the angle values.

Here, consideration will be given to the relationship between the annular scratch defect Cu and the sum tracks Tl to Tn in FIG. 2. When the sum track Ti with the annular scratch defect Cu is compared to the other sum tracks without the annular scratch defect Cu, it is found in FIG. 2 that the number of defects detected in the sum track Ti is much larger than that in the other sum tracks. Even if some other sum tracks have the island defect Id, the number of defects is distributed to the individual sum tracks. As a result, the total number of defects in each of such sum tracks is not so much larger than that in the sum track Ti with the annular scratch defect Cu. Thus, FIG. 3A shows the distribution of the number of defects in the radial histogram with respect to the annular scratch defect Cu and the island defect Id.

Next, consideration will be given to the relationship between the island defect Id and the sum angle areas θl to θm in FIG. 2. When the sum angle areas θi, θi+1 with the island defect Id are compared to the other sum angle areas without the island defect Id, it is found in FIG. 2 that the number of defects detected in the sum angle areas θi, θi+1 is much larger than that in the other sum angle areas. Even if some other sum angle areas have the annular scratch defect Cu, the number of defects is distributed to the individual sum angel areas. As a result, the total number of defects in each of such sum angle areas is not so large comparing to that in the sum angle areas θi, θi+1 with the island defect Id. Thus, FIG. 3B shows the distribution of the number of defects in the angular histogram with respect to the annular scratch defect Cu and the island defect Id.

As described above, when a radial histogram is calculated from the detected defects, it is shown that the number of defects in the sum track with the annular scratch defect Cu is much larger than the standard deviation of the histogram. Similarly, when an angular histogram is calculated from the detected defects, it is shown that the number of defects in the sum angle area with the island defect Id is much larger than the standard deviation of the histogram.

The deviation of the radial histogram is related to the annular scratch defect. This is because the annular scratch defect is on a circumference of an annular of a predetermined radius. Further, the deviation of the angular histogram is related to the island defect. This is because the island defect is included in about one or two angle areas of the disk divided into equal angles in the circumferential direction. However, when the division angle is reduced, the number of angle areas in which the island defect is included is slightly increased.

Here, the track width is set to a predetermined radius range in which an annular scratch defect occurs. For example, the disk 1, or DTM is divided into a large number of sum tracks at a predetermined width in the range of radial widths from 5 μm to 10 μm in the radial direction of the DTM. Then, the total number of defects in each of the sum tracks is calculated to generate data of the radial histogram. It is preferable that the width of the sum tracks is in the range of 5 μm to 10 μm, because in most cases the common annular scratch defect occurs in one sum track, or in three sum tracks (middle and two adjacent sum tracks).

Similarly, in the case of the island defect in the DTM, the disk is divided into equal angles in the circumferential direction, to set a large number of fan-shaped sum angle areas with a predetermined angle in the range of 0.5° to 3°. Then, the total number of defects in each of the sum angle areas is calculated to generate data of the angular histogram. It is preferable that the angle of the sum angle areas is in the range of 0.5° to 3°, because in most cases the common island defect occurs in one sum angle area, or in three sum angle areas (middle and two adjacent sum angle areas).

Hereinafter, a description will be given of the step-by-step process for performing the annular scratch defect determination and the island defect determination, to determine the defect shape by referring to the standard deviations.

Returning to FIG. 1, reference numeral 15 denotes a data processor for the step-by-step process of determining the annular scratch and the island defect. The data processor 15 includes an MPU 16, a memory 17, a monitor (display device) 18, and an interface 19, and the like. These components are connected to each other by a bus 20.

The memory 17 stores a defect detection program 17a, a radial/angular histogram generation program 17b, a radial/angular deviation calculation program 17c, a defect shape determination program 17d, a continuity judgment program 17e, a defect size classification program 17f, and a helical scan program 17g or other programs. The memory 17 also includes an operation area 17h.

Further, various data files and the like are stored in an external storage device 21, such as a hard disk device (HDD), connected to the data processor 15 through the interface 19.

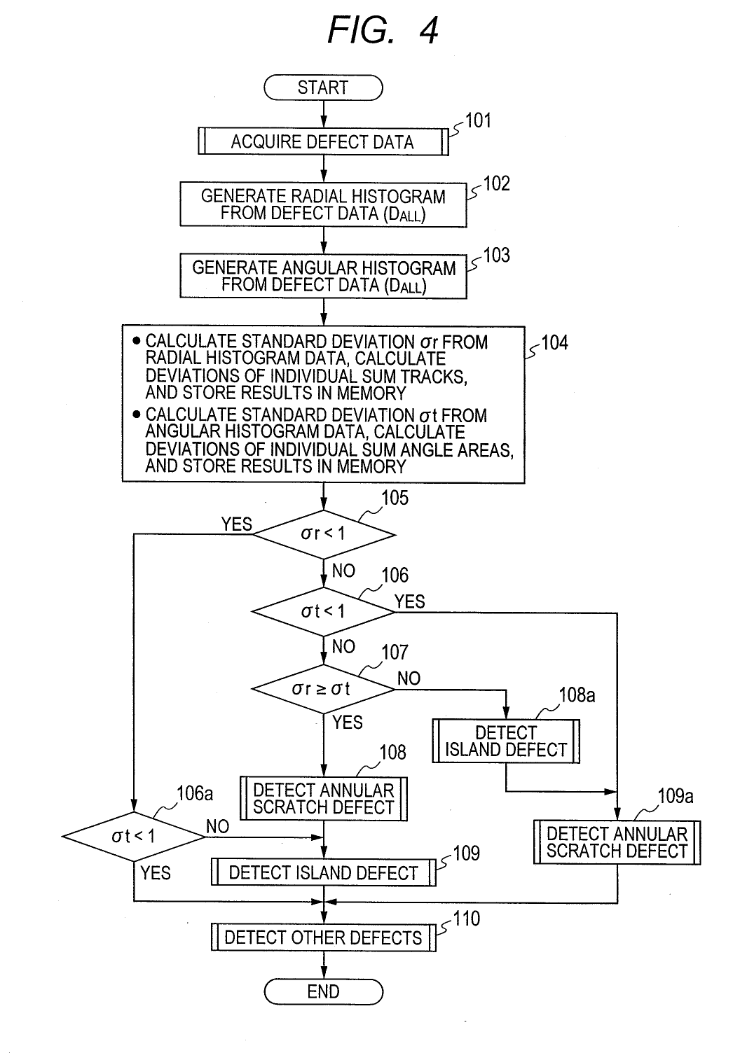

FIG. 4 is a flow chart illustrating the step-by-step determination of the annular scratch defect and the island defect according to the standard deviations. The determination will be described by the process of each of the programs described above.

The defect detection program 17a is executed by the MPU 16. The MPU 16 first calls and executes the helical scan program 17g based on the defect detection program 17a. Then, the MPU 16 controls the R·θ stage 3 under the helical scan program 17g to helically scan the disk 1, and acquires defect data of the entire surface of the disk 1, as well as the R·θ coordinates of the defects. Then, the MPU 16 controls to store the acquired data in the defect memory 14. Next, the MPU 16 controls to receive the defect data of the entire surface of the disk 1 from the defect memory 14 through the interface 19. Then, the MPU 16 controls to store the received defect data in the operation area 17h of the memory 17. In this way, the defect data (DALL) of the entire surface of the disk 1 is acquired and stored in the operation area 17h (step 101).

After the above step, the MPU 16 calls and executes the radial/angular histogram generation program 17b.

The radial/angular histogram generation program 17b is executed by the MPU 16. Based on this program, the MPU 16 sets the sum tracks Tl to Tn (see FIG. 2) with a radius width of 6 μm on the entire surface of the disk 1. Then, with respect to the acquired defect data (DALL) stored in the operation area 17h, the MPU 16 counts the number of defects in each sum track, and calculates the total number of the defects to generate radial histogram data. Then, the MPU 16 stores the generated radial histogram data in the operation area 17h (step 102).

Next, the MPU 16 divides the disk 1 into equal angles in the circumferential direction at an equal angle of 1°, to set the fan-shaped sum angle areas θl to θm (see FIG. 2) to calculate the total number of defects. Then, with respect to the acquired defect data (DALL), the MPU 16 counts the number of defects in each sum angle area, and calculates the total number of the defects to generate angular histogram data. Then, the MPU 26 stores the generated angular histogram data in the operation area 17h (step 103).

Next, the MPU 16 calls and executes the radial/angular deviation calculation program 17c. The radial/angular deviation calculation program 17c is executed in the following steps. First the MPU 16 calculates the standard deviation σr of the radial histogram stored in the operation area 17h. In addition, the MPU 16 calculates deviations of the individual sum tracks. Then, the MPU 16 stores the results in the memory (operation area 17h). Further, the MPU 16 calculates the standard deviation σt of the angular histogram stored in the operation area 17h. In addition, the MPU 16 calculates deviations of the individual sum angle areas. Then, the MPU 16 stores the results in the memory (operation area 17h) (step 104).

Next, the MPU 16 judges whether the standard deviation σr is less than 1 (step 105). When the standard deviation σr is less than 1, it is judged as YES in step 105, assuming there is no annular scratch defect. Then, the MPU 16 judges whether the standard deviation σt is less than 1 in step 106a. When the standard deviation σt is less than 1, it is judged as YES in step 106a, assuming there is no island defect. The MPU 16 switches to a process of step 110 to detect other defects.

If NO in step 106a, the MPU 16 switches to a process of island defect detection in step 109.

When the standard deviation σr is 1 or more in the judgment in step 105, it is judged as NO in step 105. Then, the MPU 16 judges whether the standard deviation σt is less than 1 in step 106. When the standard deviation σt is less than 1, it is judged as YES in step 106, assuming there is no island defect. The MPU 16 moves to a process of annular scratch defect detection in step 109a. When the standard deviation σt is 1 or more, it is judged as NO in step 106. Next, the MPU 16 calls and executes the defect shape determination program 17d.

Here, the defect shape determination program 17d is executed by the MPU 16. Based on this program, the MPU 16 classifies the defect detection into annular scratch defect detection, island defect detection, and other defect detection. Then, the MPU 16 performs the defect detection process by referring to the standard deviations 94 r and σt with respect to the defect data of the disk 1 stored in the operation area 17h.

More specifically, the MPU 16 first compares the standard deviations σr and σt, and judges whether σr is larger than σt (step 107). In this way, the MPU 16 judges the larger one among the two standard deviations, and performs the annular scratch defect detection process or the island defect detection process according to the judgment result. It is to be noted that the annular scratch defect detection process includes the case in which the two standard deviations are equal to each other.

As a result of the judgment in step 107, when the standard deviation σr of the radial histogram is larger than or equal to the standard deviation σt of the angular histogram, the MPU 16 first performs the annular scratch defect detection process (step 108). In this case, the MPU 16 sequentially detects an annular scratch defect in each of the sum tracks, starting from the sum track with the largest deviation of the deviations calculated in step 104 with respect to the standard deviation σr calculated from the radial histogram, to the sum track with the standard deviation σr.

At this time, the MPU 16 calls and executes the continuity judgment program 17e to perform the annular scratch defect detection. When a predetermined number, for example, 100 or more continuous defects (see FIG. 3A) are present in the sum track with a deviation larger than the standard deviation σr, it is determined that the continuous defects are an annular scratch defect. In this case, it is also possible to approximate the continuous defects by a circular arc. When the defects can be approximated by a circular arc, the MPU 16 can select them as an annular scratch defect. Here, the sum track is circular, so that the circular approximation is applied if necessary.

As described above, the defects are determined as a annular scratch defect. Then, a series of defect coordinates is registered as the single annular scratch defect in the operation area 17h. At the same time, the defects of the annular scratch defect are deleted from the defect data (DALL) that have been acquired and stored in the operation area 17h.

Note that in the above case, the defects are assumed to be continued by ignoring about 1 to 10 missing defects. The number of missing defects is determined depending on the sensitivity of defect detection of the apparatus. In other words, the higher the detection sensitivity, the smaller the number of missing defects.

At the time when the detection reaches the track corresponding to the standard deviation σr in the radial histogram, the MPU 16 ends the annular scratch defect detection process, and switches to the next step of the island defect detection (step 109).

Next, the MPU 16 enters the island defect detection process (step 109). The MPU 16 detects an island defect in each of the sum angle areas, starting from the sum angle area with the largest deviation of the deviations calculated in step 104 with respect to the standard deviation σt calculated from the angular histogram, to the sum angle area with the standard deviation σt. Also in the case of the island defect detection, the MPU 16 calls and executes the continuity detection program 17e to perform the detection process. The island defect is detected by grouping a predetermined number of continuous defects, and judging an island defect among the grouped continuous defects when the number of defects is, for example, 100 or more (see FIG. 3B). Upon detection of the island defect, the center coordinates are calculated as a single defect, and a plurality of coordinates of the position of the defect are registered in the operation area 17. At the same time, the defects determined to be the island defect are deleted from the defect data (DALL) that have been acquired and stored in the operation area 17h.

Next, the MPU 16 performs the defect determination of detecting other defects with respect to the remaining defect data (DALL) (step 110). Other defects include on-line defect, isolated defect of a plurality of continuous defects, or other shape defects.

In the other defect detection, the MPU 16 calls the continuity judgment program 17e to perform a continuity judgment process with respect to all of the remaining defect data stored in the operation area 17h. The process includes the following steps: searching a defect among the remaining acquired defect data (DALL) which has a center coordinate data in the range of the diameter of the laser beam spot L from a center coordinate of a defect of interest which is selected from the remaining acquired defect data (DALL); when such defect is found as a result of the search, grouping the defects into a single defect; further searching for other data using the coordinate of the grouped defect data as new center coordinate, in the radial direction and also in the circumferential direction; grouping the defects found as a result of the search into a single defect; and registering each of the defects in the operation area 17h as a single defect occurring in a continuous range.

As a result of the determination in step 107, when the standard deviation σt of the angular histogram is larger than the standard deviation σr of the radial histogram, the island defect detection is first performed, followed by the annular scratch defect detection. In other words, contrary to the process described above, the island defect detection process (step 108a) is operated at first, and then the annular scratch defect detection process described above is operated (step 109a). Finally, the other defect judgment process (step 110) is performed.

It is to be noted that, in this case, when the standard deviations σr and σt are equal to each other, the process flow from step 108a to step 109a may be selected.

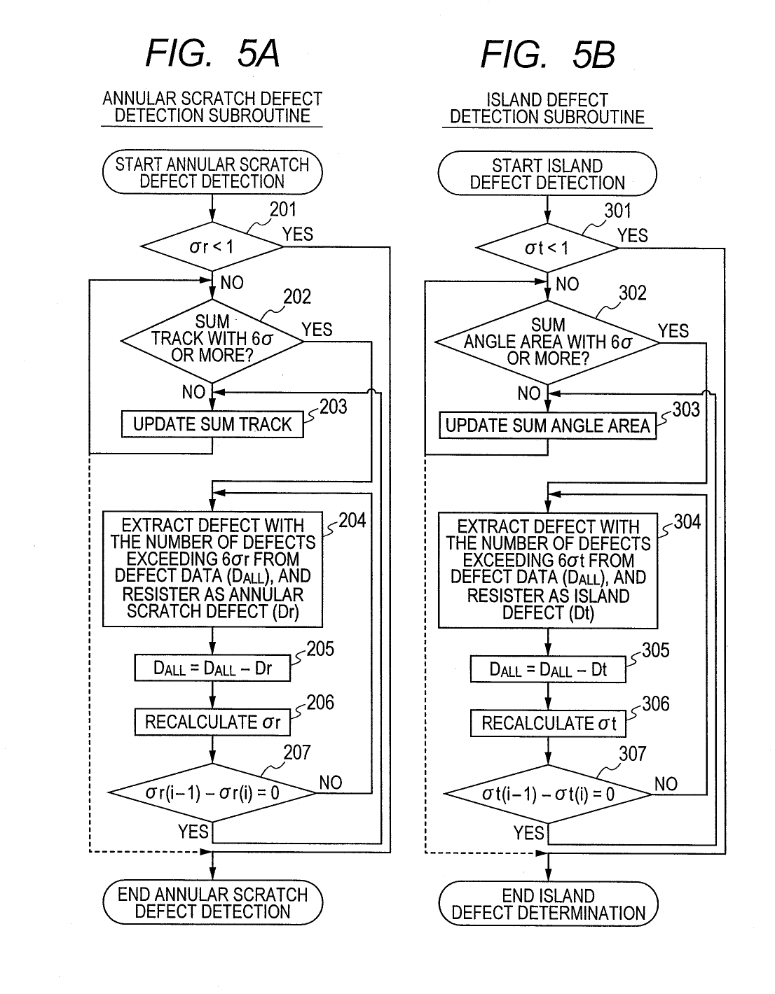

FIG. 5A is a flow chart illustrating a simple process of the annular scratch defect detection.

The annular scratch defect detection process of step 108 in FIG. 4 is performed in the flow of the annular scratch defect detection process shown in FIG. 5A.

In FIG. 5A, the MPU 16 first judges whether the standard deviation σr is 1 or more (step 201). When σr is 1 or more, the MPU 16 performs the process of the next step 202. Otherwise, the MPU 16 ends the process here, and returns to the main routine.

It is to be noted that each of the processes here is a subroutine process of the annular scratch defect detection or the island defect detection, which is continued from the main routine of the process of FIG. 4 according to the result of step 107.

Next, the MPU 16 judges whether the number of defects in each sum track is 6 σr or more (step 202). If NO in step 202, the MPU 16 updates the sum track (step 203), and returns to step 202. When there is no track left to be updated, the MPU 16 ends the process here, and returns to the main routine of FIG. 4 (see the dotted line part).

If YES in the judgment in step 202, the MPU 16 extracts continuous defects in each sum track with a deviation of 6 σr or more, which is at least 6 times the standard deviation of the radial histogram, from the acquired defect data (DALL), as an annular scratch defect (Dr) when the number of the defects exceeds 6 σr, namely, 6 times the standard deviation σr. Then, the MPU 16 sequentially registers the extracted continuous defects, as the annular scratch defect, in the operation area 17h (step 204). Then, from DALL=DALL−Dr, the MPU 16 deletes the annular scratch defect data (Dr) from the original defect data (DALL) (step 205).

If there is no annular scratch defect (Dr), the MPU 16 determines Dr=0, and switches to the next step. It is also possible to detect the annular scratch defect (Dr) with the number of defects being 5 σr or more, instead of 6 σr as described above.

Next, the MPU 16 calculates a standard deviation σri with respect to the new defect data (DALL=DALL−Dr) (step 206). Then, the MPU 16 judges whether the previously calculated standard deviation σr(i−1)−σri=0 is established (step 207).

If the annular scratch defect (Dr) with the number of defects being 6 σr (or 5 σr) or more is not detected in step 204, the result is Dr=0. In this case, the difference between the standard deviation σr(i−1) and the standard deviation σri is “0”.

If NO in the above judgment, the MPU 16 returns to step 204. If YES in the judgment, the MPU 16 returns to step 203 and updates the sum track.

In this embodiment, 5 σr or 6 σr or more continuous defects are extracted as the annular scratch defect (Dr) in each sum track. Because the experience shows that in most of the annular scratch defects causing a problem in the DTM, as shown in FIG. 3B, the number of defects is 5 σr or more in the distribution of the number of defects on the radial histogram. Thus, the annular scratch defect can be distinguished from the island defect by 5 σr.

FIG. 5B is a flow chart illustrating a simple process of the island defect detection.

The island defect detection process of step 108a in FIG. 4 is performed in the flow of the island defect detection process shown in FIG. 5B.

In FIG. 5B, the MPU 16 first judges whether the standard deviation σt exceeds 1 (step 301). When σt is 1 or more, the MPU 16 performs the process of the next step 302. Otherwise, the MPU 16 ends the process here, and returns to the main routine.

Next, the MPU 16 judges whether the number of defects in each sum angle area is 6 σt or more (step 302). If NO in step 302, the MPU 16 updates the sum angle area (step 303), and returns to step 302. When there is no sum angle area left to be updated, the MPU 16 ends the process here, and returns to the main routine shown in FIG. 4 (see the dotted line part).

If YES in the judgment in step 302, the MPU 16 extracts continuous defects in each sum angle area with a deviation of 6 σt or more, which is at least 6 times the standard deviation of the angular histogram, from the acquired defect data (DALL), as an island defect (Dt) when the number of the defects exceeds 6 σt, namely, 6 times the standard deviation σt. Then, the MPU 16 sequentially registers the extracted continuous defects, as the island defect (Dt), in the operation area 17h (step 304). Then, from DALL=DALL−Dt, the MPU 16 deletes the island defect data (Dt) from the original defect data (DALL) (step 305).

If there is no island defect (Dt), the MPU 16 determines Dt=0, and switches to the next step. It is also possible to detect the island defect (Dt) with the number of defects exceeding 5 σt, instead of 6 σr as described above.

Then, the MPU 16 calculates a standard deviation σti with respect to the new defect data (DALL=DALL−Dt) (step 304). Then, the MPU 16 judges whether the previously calculated standard deviation σt(i−1)−σti=0 is established (step 305).

If there is no island defect (Dt) with the number of defects exceeding 6 σt (or 5 σt) detected in step 304, the result is Dt=0. In this case, the difference between the standard deviation σt(i−1) and the standard deviation σti is “0”.

If NO in the judgment of step 305, the MPU 16 returns to step 304. If YES in the judgment of step 305, the MPU 16 returns to step 303 and updates the sum angle area.

In this embodiment, 5 σt or 6 σt or more continuous defects are extracted as the island defect (Dt) in the angular histogram. Because the experience shows that in most of the island defects causing a problem in the DTM, the number of defects exceeds 5 σt in the distribution of the number of defects on the angular histogram. Thus, the island defect can be distinguished from the annular scratch defect by 5 σt.

When the island defect detection process of FIG. 5B is first performed, the island defect data is subtracted from the acquired defect data (DALL) in step 204 which is the next process of the annular defect detection. Similarly, when the annular scratch defect detection process of FIG. 5A is first performed, the annular scratch detect data is subtracted from the acquired defect data (DALL) in step 304 which is the next process of the island defect detection.

In this embodiment, the deviation of the sum track for detecting the annular scratch defect is set to 6 times the standard deviation, or the deviation of the sum angle area for detecting the island defect is set to 6 times the standard deviation. However, it is possible to set the deviation to at least 3 times (3 σ) the standard deviation. Further, the number of continuous defects detected may be different in the annular scratch defect detection process and in the island defect detection process.

When the process of FIG. 4 is completed, the defect size classification program 17f is executed by the MPU 16. The MPU 16 executes the program as a size classification process. In this process, the MPU 16 calculates the area of one grouped defect. Then, the MPU 16 determines the size of the defect from the calculated area, to classify each defect.

Note that when the position data POS is stored in the defect memory 14 in addition to the received light levels of reception signals from the defect positions, it is possible to obtain the received light level of the signal of each defect corresponding to the position at which the defect occurs. Further, with respect to the detection signal with only one peak indicating an isolated defect, when the voltage level of the signal exceeds a threshold, the defect determination circuit 13 classifies the voltage level into one of the 5 stages (extra large, large, medium, small, extra small) according to the classification criteria. In this way, each defect can be classified and stored according to the position at which the defect occurs.

As described above, this embodiment is designed to first perform the annular scratch defect detection process or island defect detection process with the larger standard deviation, to determine the annular scratch defect or the island defect. However, the present invention is not limited to the above embodiment, and it is also possible to first perform the detection process with the smaller standard deviation to determine the annular scratch defect or the island defect.

The above embodiment exemplifies the laser beam as the irradiation light irradiated on the inspection area S of the disk 1. In this case, it is preferable to use a laser beam of an S polarization. However, the present invention is not limited to the case in which the irradiation light is the laser beam. It goes without saying that the irradiation light may be white light.

Further, the above embodiment has been described focusing on the apparatus for inspecting surface defects of a magnetic disk. However, the inspection target according to the present invention is not limited to the magnetic disk, and any other disk-shaped substrates (disks) such as wafer and CD may also be used.

Still further, although the above embodiment uses the R·θ helical scan as the scan of the disk, the present invention is not limited to such a helical scan. It goes without saying that an XY two-dimensional scan may also be used.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A surface defect inspection method of a disk, comprising the steps of:
a detection data acquisition step for inspecting an entire surface of the disk to detect defects, and acquiring data of the detected defects together with position coordinates on the disk;
a radial histogram generation step for dividing the entire surface of the disk into a large number of areas at a predetermined width in the radial direction of the disk, to set a large number of sum tracks to calculate the total number of the defects, and generating histogram data containing the number of defects in each of the large number of sum tracks in radius, with the number of defects in each sum track as a frequency; or an angular histogram generation step for dividing the entire surface of the disk into a large number of angles at a predetermined equal angle in a circumferential direction of the disk, to set a large number of sum angle areas to calculate the total number of the defects, and generating histogram data containing the number of defects in each of the large number of sum angle areas in angle, with the number of defects in each sum angle area as a frequency;
a step for calculating the standard deviation of the histogram data containing the number of defects detected in the sum tracks in radius, and calculating the standard deviation of the histogram data containing the number of defects detected in the sum angle area in angle; and
a defect inspection step for detecting an annular scratch defect in the histogram data containing the number of defects in radius, with respect to each sum track with a deviation higher than the standard deviation of the particular histogram data, or for detecting an island defect in the histogram data containing the number of defects in angle, with respect to each sum angle area with a deviation higher than the standard deviation of the particular histogram data.

2. The surface defect inspection method of a disk according to claim 1,
wherein the method comprises the radial histogram generation step and the angular histogram generation step,
wherein the position coordinates on the disk are the two-dimensional coordinates with the axis of the position in the radial direction and the axis of the angle in the circumferential direction,
wherein the radial histogram generation step counts the number of the detected defects by referring the positions at which the defects are detected in the radial direction, and
wherein the angular histogram generation step counts the number of the detected defects by referring to the angles at which the defects are detected in the circumferential direction.

3. The surface defect inspection method of a disk according to claim 2,
wherein the disk is a magnetic disk, and
wherein the disk surface defect inspection method further includes the steps of:
detecting the annular scratch defect in each sum track with a deviation higher than the standard deviation of the radial histogram data; and
detecting the island defect in each sum angel area with a deviation higher than the standard deviation of the angular histogram data.

4. The surface defect inspection method of a disk according to claim 2,
wherein each of the sum tracks with a deviation higher than the standard deviation of the radial histogram data has a deviation 6 times the standard deviation or more, and
wherein each of the sum angle areas with a deviation higher than the standard deviation of the angular histogram data has a deviation 6 times the standard deviation or more.

5. The surface defect inspection method of a disk according to claim 4,
wherein the annular scratch defect detection is performed by selecting continuous defects when the number of the defects is 3 times the standard deviation or more of the radial histogram data, and
wherein the island defect detection is performed by selecting continuous defects when the number of the defects is 3 times the standard deviation or more of the angular histogram data.

6. The surface defect inspection method of a disk according to claim 3,
wherein the standard deviation of the radial histogram data is compared to the standard deviation of the angular histogram data, and
wherein the annular scratch defect detection or the island defect detection is first performed, corresponding to the larger standard deviation.

7. An apparatus for inspecting surface defects of a disk, the apparatus comprising:
defect data acquisition means for inspecting an entire surface of the disk to detect defects, and acquiring data of the detected defects together with position coordinates on the disk;
radial histogram generation means for dividing the entire surface of the disk into a large number of areas at a predetermined width in a radial direction of the disk, to set a large number of sum tracks to calculate the total number of the defects, and generating histogram data containing the number of defects in each of the large number of sum tracks in radius, with the number of defects in each sum track as a frequency; or angular histogram generation means for dividing the entire surface of the disk into a large number of angles at a predetermined equal angle in a circumferential direction of the disk, to set a large number of sum angle areas to calculate the total number of the defects, and generating histogram data containing the number of defects in each of the large number of sum angle areas in angle, with the number of defects in each sum angle area as a frequency;
means for calculating the standard deviation of the histogram data containing the number of defects in radius, and calculating the standard deviation of the histogram data containing the number of defects in angle; and
defect inspection means for detecting an annular scratch defect in the histogram data containing the number of defects in radius, with respect to each sum track with a deviation higher than the standard deviation of the particular histogram data, or for detecting an island defect in the histogram data containing the number defects in angle, with respect to each sum angle area with a deviation higher than the standard deviation of the particular histogram data.

8. The apparatus for inspecting surface defects of a disk according to claim 7,
wherein the apparatus comprises the radial histogram generation means and the angular histogram generation means,
wherein the position coordinates on the disk are the two-dimensional coordinates with the axis of the position in the radial direction and the axis of the angle in the circumferential direction,
wherein the radial histogram generation means counts the number of the detected defects by referring to the positions at which the defects are detected in the radial direction, and
wherein the angular histogram generation means counts the number of the detected defects by referring to the angles at which the defects are detected in the circumferential direction.

9. The apparatus for inspection surface defects of a disk according to claim 8,
wherein the disk is a magnetic disk, and
wherein the apparatus includes the steps of:
detecting the annular scratch defect in each sum track with a deviation higher than the standard deviation of the radial histogram data; and
detecting the island defect in each sum angel area with a deviation higher than the standard deviation of the angular histogram data.

10. The apparatus for inspection surface defects of a disk according to claim 8,
wherein each of the sum tracks with a deviation higher than the standard deviation of the radial histogram data has a deviation 6 times the standard deviation or more, and
wherein each of the sum angle areas with a deviation higher than the standard deviation of the angular histogram data has a deviation 6 times the standard deviation or more.

11. The apparatus for inspection surface defects of a disk according to claim 10,
wherein the annular scratch defect detection is performed by selecting continuous defects when the number of the defects is 3 times the standard deviation or more of the radial histogram data, and
wherein the island defect detection is performed by selecting continuous defects when the number of the defects is 3 times the standard deviation or more of the angular histogram data.

12. The apparatus for inspection surface defects of a disk according to claim 8,
wherein the standard deviation of the radial histogram data is compared to the standard deviation of the angular histogram data, and
wherein the annular scratch defect detection or the island defect detection is first performed, corresponding to the larger standard deviation.
